(19) United States
(12) Patent Application Publication
(10) Pub. No.: US 2007/0162606 A1
(43) Pub. Date: Jul. 12, 2007

(54) Communication device capable of setting a mood mode and method for sending and receiving a mood mode by the communication device

(75) Inventors: Neng-Zhe Chen, Taipei (TW); Hui-Kuo Tsao, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/328,249

(22) Filed: Jan. 10, 2006

(51) Int. Cl. G06F 15/16

(52) U.S. Cl. 709/227; 715/700; 715/753

(57) ABSTRACT

The present invention discloses a communication device capable of setting a mood mode and a method for sending and receiving a mood mode by the communication device, that a communication device can independently use a low power transceiver module of the communication device to receive or send a mood from or to any other communication device having the same mood, and the communication device can be set up with a specified mood mode in a simple manner, such that one user of a communication device can easily find another user of another communication device having the same mood within the range of a short distance.

### FIELD OF THE INVENTION

The present invention relates to a communication device capable of setting a mood mode and a method for sending and receiving a mood mode by the communication device, and more particularly to a communication device that uses a low power transceiver module to receive or send a mood from or to any other communication device with having the same mood.

### BACKGROUND OF THE INVENTION

In recent years, various information products are developed rapidly and bring tremendous convenience to our life and these products become an indispensable part of our life. As various different information products are introduced constantly to the market, people demand more functions and higher quality of the information products. To meet the consumer requirements, manufactures constantly add new functions to the information products. As the communication network technology advances, mobile phones (or handsets) tend to have small size, full function, and low price, and thus the mobile phones are appreciated increasingly by users and the mobile phones have become a popular communication tool. Users can quickly communicate with friends or business associates through a mobile phone, and thus mobile phones provide a much simpler, easier, and quicker service than the traditional cable telephone.

In the present fast-pace society, mobile phones are a quick and convenient communication tool that can install software such as a game, a telephone directory, a voice mail, and an alarm, etc to provide additional services to users and effectively enhance the mobile phone and meet the all-in-one requirement. From the popularity of portable communication products, it is known that the competition in the present information market is very severe, and different brands of mobile phones and personal digital assistants are available in market. A manufacturer will be eliminated by the market competition, if the manufacturer is unable to meet the consumer's increasingly high requirements. Therefore, it is an important index to indicate the level of manufacturing technology of a portable communication product manufacturer by evaluating and determining whether or not the manufacturer has the capability of providing more convenient and effective functions for a product in the future.

Different mobile phone companies provide various different services by adding more various functions to the mobile phone. As the pace of our life becomes quicker and our work gets busier, the scope of our social life becomes narrower, and thus it is an important issue for people to find a way of releasing their pressure of the busy metropolitan life and communicating with others. Safeguarding oneself is one of the largest obstacles for metropolitans to make friends with each other. Based on the aforementioned reasons, some mobile phone companies provide a chat service through mobile phones, and such service allows a user to chart with another user without revealing the user's phone number. Such arrangement not only provides a communicating service, but also protects the users from being disturbed or harassed, and thus satisfies the personal privacy requirement. The major advantage of the chat service of a mobile phone resides on that the user's privacy can be protected and unnecessary disturbance caused by revealing the user's phone number can be avoided. All mobile phone users who use the chat service provided by a mobile phone company can communicate with each other anytime, so as to achieve the communication purpose.

The way of using the chat service of the mobile phone is described as follows:

1. Each user who wants to have the chat service through the mobile phone, the user must be registered to the system of a mobile phone company in advance, and then the system will record the user's related information including sex, age, and mobile phone number and assign a unique ID number to each registered user.

2. The chat service of the mobile phone will connect each registered user to the chat service of the mobile automatically. If a user does not need the chat service, the user simply select an offline operation for the system.

3. After a user enters into the chat service of the mobile phone, the user can input the selected conditions according to the voice instruction given by the chat service of the mobile phone. Since the chat service of the mobile phone selects another user that match the requirements and reports the corresponding ID number to the user, the user can mark down the corresponding ID number and then use a specified service number together with the ID number to dial a call to another user, and then the chat service of the mobile phone allows communications between these two parties.

4. If a user no longer needs the chat service, the user can log out from the system.

Further, the chat service of the mobile phone is a charged service provided by a mobile phone company, and such service records a plurality of user's personal data and friend-choosing conditions for randomly seeking another user who uses the chat service provided by the same mobile phone company for chatting and communication.

In the description above, the way of using the chat service of the mobile phone is relatively complicated, and it is necessary to pay a service fee for its use, and the chat service cannot promptly search another appropriate user for the chatting. For example, the user is depressed and wants to find another user having the same mood for a chat, but the user can only use the previously recorded personal data or friend-choosing conditions to randomly match another user, and thus such service cannot meet the user's requirement. Further, after two users have started chatting through the chat service of the mobile phones and want to further meet and know each other, the two users may give up such idea because both users are located at a distance apart. If the personal data and friend-choosing conditions match two or more users who use the chat service of the same mobile phone company, the chat service of the mobile phone cannot timely inform these parties, and thus the two parties may miss the opportunity of having the acquaintance from each other.

If a mobile phone manufacturer can design a novel mobile phone product to effectively avoid the foregoing occasions such as missing the opportunity of getting the acquaintance from a right candidate, being unable to chat with someone at a particular time when needed, and rigidly following the previously registered personal data and friend-choosing conditions to match other users, and effectively overcome the shortcomings of the prior art use of a mobile phone and provide a more convenient and practical function for our communication and achieve the mutual help and functional effects, users will appreciate such products. In addition, the competitiveness of such mobile phone in the market can be improved.

### SUMMARY OF THE INVENTION

In view of the shortcomings of the prior art, the inventor of the present invention conducted extensive researches and experiments, and finally invented a communication device capable of setting a mood mode and a method for sending and receiving a mood mode by a communication device in hope of contributing to the innovative ideas to the general public.

Therefore, it is a primary objective of the present invention to provide a communication device capable of setting a mood mode, wherein a control module of the communication device uses a mood editing and comparing module to output a mood editing interface on a display screen installed on the communication device, and the mood editing interface includes a plurality of mood modes on the display screen, and one of the mood modes is set as a specified mood mode. The control module outputs a mood display message on the mood display module according to the specified mood mode, and uses the low power transceiver module to convert the specified mood mode into a specified mood signal, and sends the specified mood signal out through the antenna, or receives an external specified mood signal through the antenna. The low power transceiver module converts the external specified mood signal into an external specified mood mode. The mood display module outputs a match message, after the mood editing and comparing module compares and determines that the specified mood mode and the external specified mood mode belong to the same mood mode.

Another objective of the present invention is to provide a method for sending or receiving a mood mode by a communication device, and the communication device includes necessary components required for a general communication and also comprises a low power transceiver module, an antenna, a control module, a mood editing and comparing module, and a mood display module, such that the control module uses the mood editing and comparing module to generate a mood editing interface on a display device of the communication device. After the mood editing interface has received a set specified mood mode, the display device outputs a mood display message, and uses the low power transceiver module to convert the specified mood mode into a specified mood signal and uses the antenna to transmit the specified mood signal. In the meantime, the antenna receives an external specified mood signal to be converted into an external specified mood mode by the low power transceiver module. After the mood editing and comparing module compares and determines that the specified mood mode and the external specified mood mode belong to the same mood mode, the mood display module will output a match message.

The above and other objects, features and advantages of the present invention will become apparent from the following detailed description taken with the accompanying drawings.

### BRIEF DESCRIPTION OF THE DRAWINGS

FIG. 1 is a schematic view of a structure of the invention;

FIG. 2 is a schematic view of a mood editing interface of the invention; and

FIG. 3 is a flow chart of sending and receiving a mood mode by a communication device according to the invention.

### DETAILED DESCRIPTION OF THE PREFERRED EMBODIMENTS

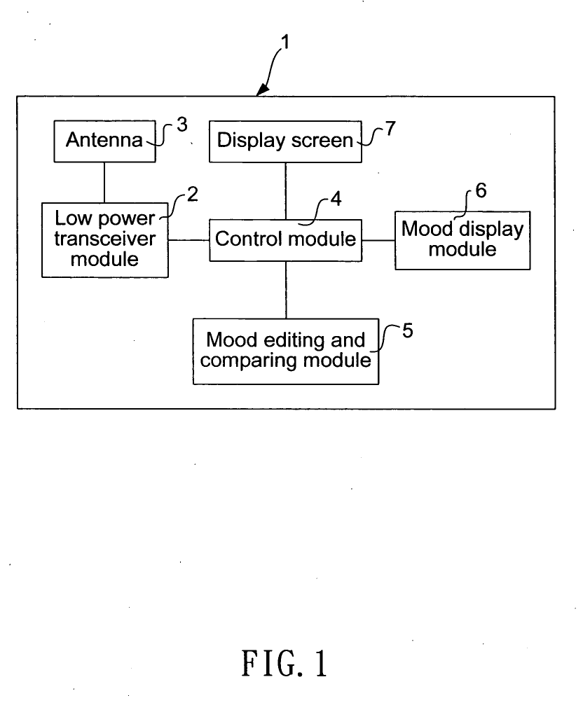

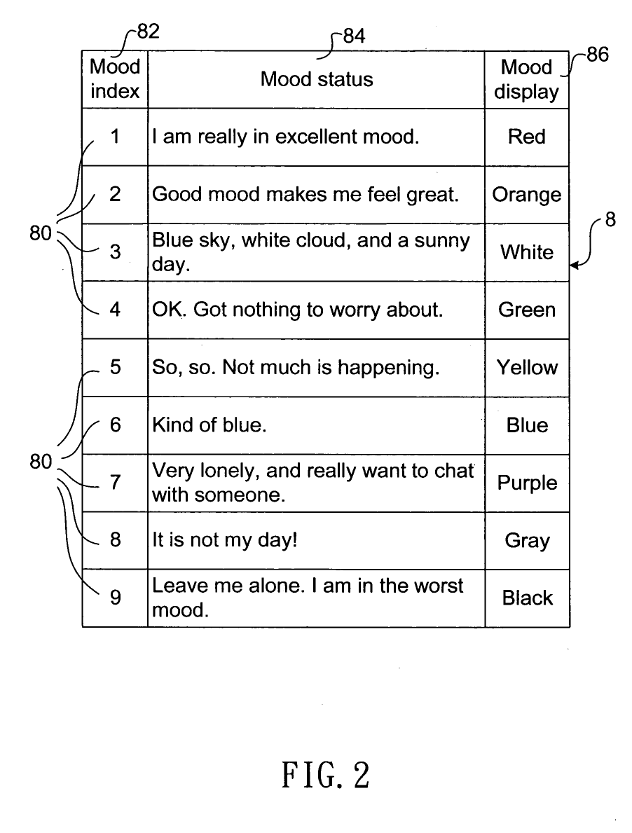

Referring to FIGS. 1 and 2 for the communication device capable of setting a mood mode and the method for sending and receiving a mood mode by the communication device of the present invention, the communication device 1 includes necessary components required for a communication and further comprises a low power transceiver module 2, an antenna 3, a control module 4, a mood editing and comparing module 5 and a mood display module 6, wherein the modules are coupled with each other, and the control module 4 can generate a mood editing interface 8 on a display screen 7 installed on the communication device 1 through the mood editing and comparing module 5, and the mood editing interface 8 outputs a plurality of mood modes 80 on the display screen 7 and records one of the mood modes 80 as a specified mood mode, such that the control module 4 outputs a mood display message on the mood display module 6 according to the specified mood mode and uses the low power transceiver module 2 to convert the specified mood mode into a specified mood signal, and then transmits the specified mood signal through the antenna 3 or receives an external specified mood signal through the antenna 3, and the low power transceiver module 2 converts the external specified mood signal into an external specified mood mode. After the mood editing and comparing module 5 compares and determines that the specified mood mode and the external specified mood mode belong to the same mood mode, the mood display module 6 will output a match message.

In the present invention as shown in FIG. 2, each mood mode 80 comprises a mood index field 82, a mood status field 84, and a mood display field 86, wherein the mood index field 82 is a display of a number, a symbol, or a color, and the mood status field 84 is a mood description in words, and the mood display field 86 is the same as the mood display message outputted after each mood mode is recorded as the specified mood mode, or the mood display field 86 is a display of a symbol or a color.

In the present invention, the mood display module 6 is disposed on the surface of the communication device 1 and at a position easy to be observed or easy to output messages. For example, the mood display module is installed at a position around the periphery of the display screen 7, or the mood display module 6 is an area display set on the display screen, and the mood display message and the match message are an image, a text, a color, or a figure, or the mood display message and the match message are a combination of an image, a text, a color, or a figure.

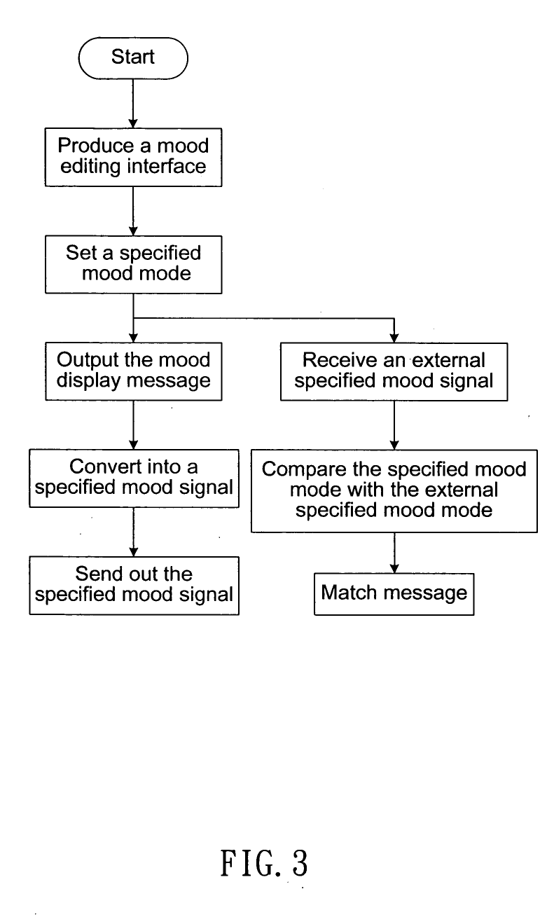

Referring to FIGS. 1 to 3 for the method for sending and receiving a mood mode by a communication device, a control module 4 of the communication device 1 uses a mood editing and comparing module 5 to generate a mood editing interface 8, and the mood editing interface 8 displays a plurality of mood modes 80 on the display screen 7, and the mood editing interface 8 receives one of the mood modes 80 to be set as a specified mood mode, and uses the mood display module 6 installed on the communication device 1 to output a mood display message according to the specified mood mode, and uses the low power transceiver module 2 of the communication device 1 to convert the specified mood mode into a specified mood signal, and sends out the specified mood signal through an antenna 3 coupled to the low power transceiver module 2. After the communication device sets up the specified mood mode, the antenna 3 can receive an external specified mood signal to be converted into an external specified mood mode by the low power transceiver module 2. After the mood editing and comparing module 5 compares and determines that the specified mood mode and the external specified mood mode belong to the same mood mode, the mood display module 6 will output a match message.

In the aforementioned communication device or method, the communication device users can independently use the low power transceiver module of the communication device to receive and send a mood to any other communication device user having the same mood, without using the service provided by any other mobile phone company, and the communication device can set up the specified mood mode in a simple manner. Within the range of a short distance, the communication device user can easily find another communication device user having the same mood, such as a communication device user who participates in various parties or social activities at a specific time and place. Such arrangement can overcome the shortcomings of the chat service provided by the prior art mobile phone.

While the invention herein disclosed has been described by means of specific embodiments, numerous modifications and variations could be made thereto by those skilled in the art without departing from the scope and spirit of the invention set forth in the claims.

What is claimed is:

1. A communication device capable of setting a mood mode, comprising:
components for a communication,
a control module, for controlling the operation of said each component;
a mood editing and comparing module, coupled to and used by said control module to produce a mood editing interface on a display screen installed on said communication device, output a plurality of mood modes on said display screen and record one of said mood mode selected as a specified mood mode;
a mood display module, coupled to said control module and outputting a mood display message thereon according to said specified mood mode;
a low power transceiver module, coupled to said control module and said mood display module and used by said control module to convert said specified mood mode into a specified mood signal and convert an external specified mood signal into an external specified mood mode; and
an antenna, coupled to said low power transceiver module for sending said specified mood signal or receiving said external specified mood signal;
said mood display module outputs a match message after said mood editing and comparing module compares and determines that said specified mood mode and said external specified mood mode belong to the same mood mode.

2. The communication device of claim 1, wherein said mood display module is disposed on said communication device and at a position easy to be observed or easy to output messages.

3. The communication device of claim 2, wherein said mood display module is disposed at a position around the periphery of said display screen.

4. The communication device of claim 2, wherein said mood display module is an area display set on said display screen.

5. The communication device of claim 2, wherein said each mood mode comprises a mood index field, a mood status field, and a mood display field, said mood index field is a number, a symbol, or a color, said mood status field is a mood description, and said mood display field is the same as a mood display message outputted after said each mood mode is selected and recorded as said specified mood mode, or said mood display field is a symbol or a color.

6. The communication device of claim 2, wherein said mood display message is an image, a text, a color, or a figure.

7. The communication device of claim 2, wherein said match message is an image, a text, a color, or a figure.

8. The communication device of claim 2, wherein said mood display message is a combination of an image, a text, a color, or a figure.

9. The communication device of claim 2, wherein said match message is a combination of an image, a text, a color, or a figure.

10. A method for sending and receiving a mood mode by a communication device having a control module to proceed with a procedure comprising the steps of:
using a mood editing and comparing module of said communication device to produce a mood editing interface, and enabling said mood editing interface to display a plurality of mood modes on a display screen of said communication device and receive a mood mode being selected and set as a specified mood mode;
using a mood display module of said communication device to output a mood display message according to said specified mood mode;
enabling a low power transceiver module of said communication device to convert said specified mood mode into a specified mood signal and send said specified mood signal out through an antenna of said communication device; and
using said antenna to receive an external specified mood signal, after said specified mood mode is set;
enabling said low power transceiver module to convert said external specified mood signal into an external specified mood mode;
enabling said mood display module to output a match message, if said mood editing and comparing module compares and determines that said specified mood mode and said external specified mood mode belong to the same mood mode.
